(19) United States
(12) Patent Application Publication
(10) Pub. No.: US 2015/0067669 A1
(43) Pub. Date: Mar. 5, 2015

(54) METHOD FOR MANAGING APPLICATION AND ELECTRONIC DEVICE THEREOF

(71) Applicant: Samsung Electronics Co., Ltd., Gyeonggi-do (KR)

(72) Inventors: Tai-Kuin Mun, Gyeonggi-do (KR); Jae-Wook Lee, Gyeonggi-do (KR)

(21) Appl. No.: 14/476,631

(22) Filed: Sep. 3, 2014

(30) Foreign Application Priority Data
Sep. 3, 2013 (KR) 10-2013-0105783

(51) Int. Cl. G06F 9/445; H04L 29/08; H04L 12/24

(52) U.S. Cl. CPC G06F 8/65; H04L 41/02; H04L 67/10; G06F 8/61
USPC 717/171; 717/176

(57) ABSTRACT

A method for managing an application and an electronic device are provided. In the method, application data for an external electronic device is determined. Application data for the external electronic device is transmitted to the external electronic device. Also, a method for managing an application in an electronic device can be implemented via various embodiments.

### PRIORITY

The present application is related to and claims the benefit under 35 U.S.C. §119(a) of a Korean patent application filed in the Korean Intellectual Property Office on Sep. 3, 2013 and assigned Serial No. 10-2013-0105783, the entire disclosure of which is hereby incorporated by reference.

### TECHNICAL FIELD

The present disclosure relates to a method for managing an application and an electronic device thereof.

### BACKGROUND

With development of an information communication technology and a semiconductor technology, an electronic device can provide various multimedia services such as a voice communication service, a video communication service, a messenger service, a broadcasting service, a wireless Internet service, a camera service, a streaming service, and a music reproduction service.

An electronic device can form a communication connection with a counterpart electronic device to transmit data to the counterpart electronic device or receive data from the counterpart electronic device. For example, as illustrated in FIG. 1, when a call is received in an electronic device 100, a user can perform communication using a counterpart electronic device 110.

### SUMMARY

As described above, since a wearable electronic device having portability has a display unit whose size is limited, it is difficult to manipulate.

To address the above-discussed deficiencies, it is a primary object to provide a method and an apparatus for transmitting an application install file for an external electronic device to the external electronic device in an electronic device.

Still another aspect of the present disclosure is to provide a method and an apparatus for determining an application install file for an external electronic device based on an install information variable included in an application install file received from a server in an electronic device.

Yet another aspect of the present disclosure is to provide a method and an apparatus for determining an external electronic device to which an application install file can be installed in an electronic device.

Further another aspect of the present disclosure is to provide a method and an apparatus for receiving an application install file for an external electronic device from a server in an electronic device.

Still another aspect of the present disclosure is to provide a method and an apparatus for updating an application list of an external electronic device based on an installation result of an application install file from the external electronic device in an electronic device.

Still further another aspect of the present disclosure is to provide a method and an apparatus for transmitting management information regarding at least one application among one or more applications included in an application list in an electronic device.

Yet another aspect of the present disclosure is to provide a method and an apparatus for controlling to perform at least one of deletion, update, and correction on an application installed to an external electronic device in an electronic device.

Yet still another aspect of the present disclosure is to provide a method and an apparatus for updating an application list of an external electronic device based on a performance result for management information from the external electronic device in an electronic device.

Yet still further another aspect of the present disclosure is to provide a method and an apparatus for receiving an application install file from a counterpart electronic device and installing the same in an electronic device.

Still yet further another aspect of the present disclosure is to provide a method and an apparatus for transmitting an installation result for an application install file to a counterpart electronic device in an electronic device.

Still another aspect of the present disclosure is to provide a method and an apparatus for performing at least one of deletion, update, and correction on at least one application installed to an electronic device based on management information received from a counterpart electronic device.

In accordance with an aspect of the present disclosure, a method for managing an application in an electronic device is provided. The method includes determining application data for an external electronic device, and transmitting the application data for the external electronic device to the external electronic device.

In accordance with another aspect of the present disclosure, a method for managing an application in an electronic device is provided. The method includes displaying a list of applications installed to an external electronic device, and transmitting management information regarding at least one application among one or more applications included in the application list to at least one external electronic device based on input information detected via an input unit of the electronic device.

In accordance with another aspect of the present disclosure, a method for managing an application in an electronic device is provided. The method includes receiving application data from a counterpart electronic device, installing the received application data, and transmitting an installation result of the application data to the counterpart electronic device.

In accordance with still further another aspect of the present disclosure, an electronic device is provided. The electronic device includes one or more displays, one or more memories, and one or more processors configured to determine application data for an external electronic device, and transmit the application data for the external electronic device to the external electronic device.

In accordance with yet another aspect of the present disclosure, an electronic device is provided. The electronic device includes one or more displays, one or more input units, one or more memories, and one or more processors configured to display an application list installed to an external electronic device on the display, and transmit management information regarding at least one application among one or more applications included in the application list to at least one external electronic device based on input information detected via the input unit.

In accordance with still yet another aspect of the present disclosure, an electronic device is provided. The electronic device includes one or more displays, one or more memories, and one or more processors configured to receive application data from a counterpart electronic device, install the received application data, and transmit an installation result of the application data to the counterpart electronic device.

Other aspects, advantages and salient features of the disclosure will become apparent to those skilled in the art from the following detailed description, which, taken in conjunction with the annexed drawings, discloses exemplary embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is an example of an electronic device and an external electronic device according to this disclosure;

FIG. 2 is an example block diagram illustrating an electronic device according to this disclosure;

FIG. 3 is an example block diagram illustrating a processor according to this disclosure;

FIG. 4 is an example flowchart illustrating a procedure for transmitting an application install file for an external electronic device to the external electronic device in an electronic device according to this disclosure;

FIG. 5 is an example flowchart illustrating a procedure for transmitting an application install file for an external electronic device to the external electronic device in an electronic device according to this disclosure;

FIG. 6 is an example flowchart illustrating a procedure for transmitting an application install file for an external electronic device to the external electronic device in an electronic device according to this disclosure;

FIG. 7 is an example flowchart illustrating a procedure for receiving an installation result for an application install file from an external electronic device in an electronic device according to this disclosure;

FIG. 8 is an example flowchart illustrating a procedure for controlling deletion, update, or correction of an application installed to an external electronic device in an electronic device according to this disclosure;

FIG. 9 is an example flowchart illustrating a procedure for controlling deletion, update, or correction of an application installed to an external electronic device in an electronic device according to this disclosure;

FIG. 10 is an example flowchart illustrating a procedure for performing installation of an application install file received from a electronic device in an counterpart electronic device according to this disclosure;

FIGS. 11A to 13C are examples of screen configurations for managing an application for an external electronic device in an electronic device according to this disclosure;

FIG. 14 is an example of an application install file according to this disclosure.

Throughout the drawings, like reference numerals will be understood to refer to like parts, components and structures.

### DETAILED DESCRIPTION

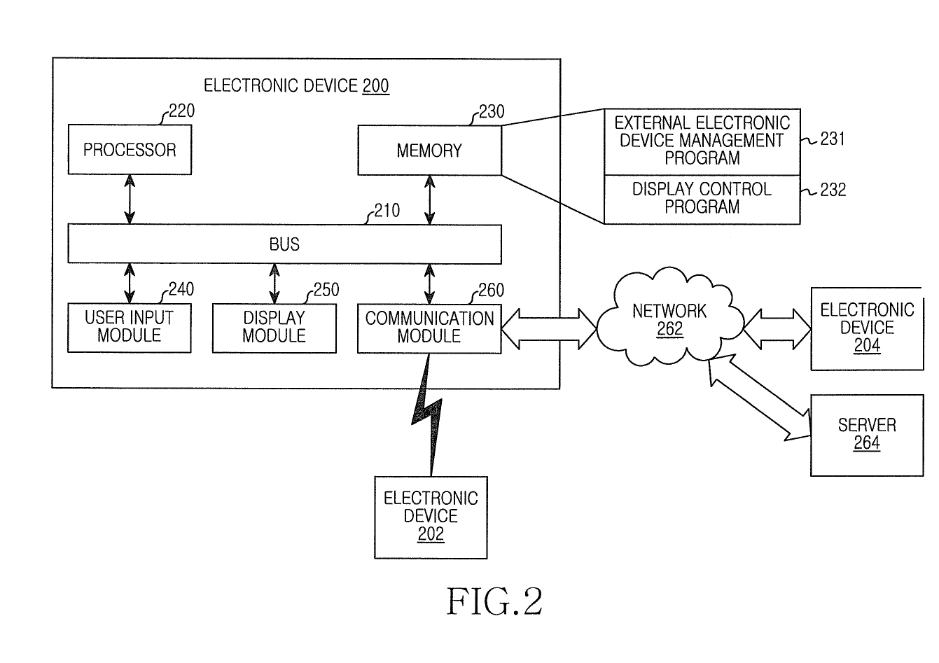

FIGS. 2 through 14, discussed below, and the various embodiments used to describe the principles of the present disclosure in this patent document are by way of illustration only and should not be construed in any way to limit the scope of the disclosure. Those skilled in the art will understand that the principles of the present disclosure can be implemented in any suitably arranged electronic device. The following description with reference to the accompanying drawings is provided to assist in a comprehensive understanding of exemplary embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. Also, descriptions of well-known functions and constructions are omitted for clarity and conciseness. In the drawing, like reference numerals are used for like elements.

FIG. 2 is an example block diagram illustrating an electronic device according to this disclosure.

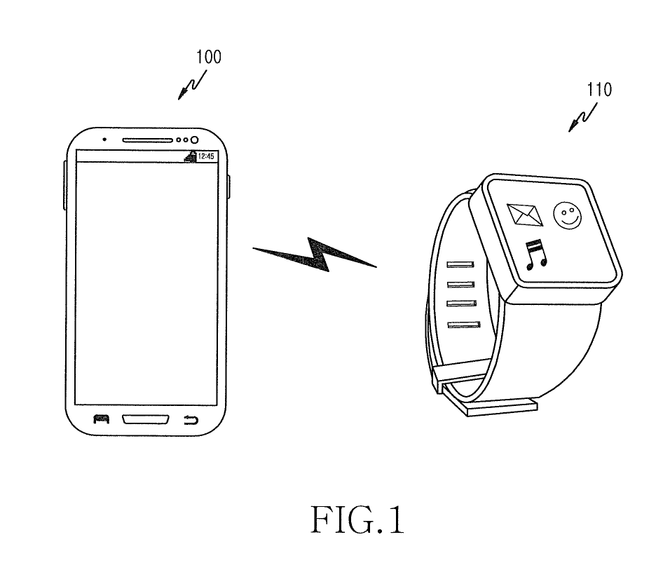

Referring to FIG. 2, the electronic device 200 can include a bus 210, a processor 220, a memory 230, a user input module 240, a display module 250, or a communication module 260. At this point, the electronic device 200 may be the electronic device 100 or 110 illustrated in FIG. 1.

The bus 210 can be a circuit for connecting elements (such as the bus 210, the processor 220, the memory 230, the user input module 240, the display module 250, or the communication module 260) included in the electronic device 200 with each other, and configured to transfer communication (such as a control message) between the elements.

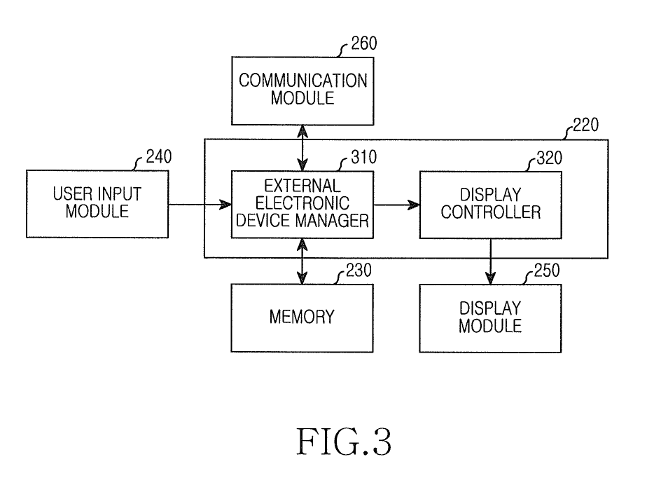

The processor 220 can be configured to receive an instruction from the elements included in the electronic device 200 via the bus 210, decipher the received instruction, and perform an operation or a data process corresponding to the deciphered instruction. At this point, the processor 220 can be configured to control to execute at least one application stored in the memory 230 and provide a service corresponding to a relevant application. For example, the processor 220 can be configured as illustrated in FIG. 3 to manage an application such as by executing an external electronic device management program 231 and a display control program 232.

Also, the processor 220 can include one or more application processors (AP) or one or more communication processors (CP). Here, the AP or the CP can be included inside the processor 220 or included inside different IC packages, respectively. Also, the AP or the CP can be included inside one IC package. The AP can be configured to drive an Operating System (OS) or an application to control a plurality of hardware or software elements, and perform various data processes and operations including multimedia data. Here, the AP can be implemented as an SoC. Also, the CP can be configured to perform at least a portion of a multimedia control function. Also, the CP can be configured to perform discrimination and authentication of a terminal inside a communication network using a Subscriber Identify Module (such as SIM card). At this point, the CP can be configured to provide a service including voice communication, video communication, a short message, or packet data to a user. Also, the CP can be configured to control data transmission/reception of the communication module 260. The AP or the CP can load an instruction or data received from at least one of a non-volatile memory or other elements connected thereto onto a volatile memory and process the same. Also, the AP or the CP can be configured to store data received from at least one of other elements or generated by at least one of other elements in a non-volatile memory. The CP can be configured to perform a function for managing a data link and convert a communication protocol in communication between an electronic device including a hardware and other electronic devices connected via a network. Here, the CP can be implemented as an SoC. Additionally, the processor 220 can further include a GPU.

The memory 230 can be configured to store data received from the processor 220 or other elements (such as a user input module 240, a display module 250, a communication module 260), or an instruction or data generated by the processor 220 or other elements. At this point, the memory can include an internal buffer or an external buffer.

Also, the memory 230 can include an external electronic device management program 231 and a display control program 232. At this point, each application can be configured as a programming module, and each programming module can be configured as a software, a firmware, a hardware, or a combination of two or more of these.

The external electronic device management program 231 can include at least one software element for managing an application. For example, the external electronic device management program 231 can be configured to determine an application install file for an external electronic device based on an install information variable included in the application install file received from a server (such as server 264). Here, the install information variable can include information configured to determine an external electronic device to which an application install file can be installed. In case of the application install file for the external electronic device, the external electronic device management program 231 can be configured to control to transmit the application install file to the external electronic device via the communication module 260. After that, the external electronic device management program 231 can be configured to update an application list of the external electronic device based on an installation result of the application install file received from the external electronic device via the communication module 260.

Also, the external electronic device management program 231 can be configured to control to request the display control program 232 to display a list of applications installed to the external electronic device. The external electronic device management program 231 can be configured to control to transmit management information regarding at least one application among one or more applications included in an application list to an external electronic device via the communication module 260 based on input information detected via the user input module 240. Here, the management information can include at least one of deletion, update, and correction of an application. In case of transmitting the management information to an external electronic device, the external electronic device management program 231 can be configured to receive a performance result of the management information from the external electronic device, and update an application list of the external electronic device based on the performance result of the management information.

The display control program 232 includes at least one software element configured to control to display screen configuration for managing an application via the display module 250. For example, the display control program 232 can be configured to control to display a list of applications installed to an external electronic device via the display module 250 according to a request of the external electronic device management program 231.

Also, the memory 230 can include a built-in memory or an external memory. The built-in memory can include at least one of a volatile memory (such as DRAM, SRAM, SDRAM) or a non-volatile memory (such as OTPROM, PROM, EPROM, EEPROM, mask ROM, flash ROM, NAND flash memory, NOR flash memory). At this point, the built-in memory can be a Solid State Disk (SSD). The external memory can include at least one of CF, SD, Micro-SD, Mini-SD, xD, and a memory stick.

Also, the memory 230 can further include a kernel, a middle ware, and an Application Programming Interface (API). The kernel can be configured to control or manage system resources (such as a bus 210, a processor 220, or a memory 230) used for executing an operation or a function implemented in the other programming modules (such as a middle ware, an API, or an application). Also, the kernel can be configured to provide an interface allowing a middle ware, an API, or an application to access an individual element of the electronic device 200 and control or manage the same. The middle ware can be configured to perform a mediation role so that an API or an application can communicate with the kernel to give and take data. Also, the middle ware can be configured to perform load balancing for a task request using a method of assigning an order of priority that can use a system resource (such as the bus 210, the processor 220, or the memory 230) of the electronic device 200 to task requests received from at least one application. An API can be an interface configured to allow an application to control a function provided by the kernel or the middle ware, and can include at least one interface or a function configured to control file control, window control, image processing or character control.

The user input module 240 can be configured to receive an instruction or data from a user and transfer the same to the processor 220 or the memory 230 via the bus 210. For example, the user input module 240 can include a touch panel, a pen sensor, a key or an ultrasonic input unit. For example, the touch panel can be configured to recognize a touch input using at least one of capacitive, resistive, infrared, and ultrasonic methods. Here, the touch panel can further include a controller. In case of a capacitive type, not only a direct touch but also proximity recognition can be possible. The touch panel can further include a tactile layer. At this point, the touch panel can be configured to provide a tactile reaction to a user. For example, a pen sensor can be implemented using a method which is the same or similar to receiving a user's touch input, or a separate sheet for recognition. For example, a key can include a keypad or a touch key. For example, an ultrasonic input unit can be a unit for detecting a sound wave using a microphone to determine data in an electronic device via a pen generating an ultrasonic signal, and allows wireless recognition.

The display module 250 can be configured to display a video, an image, or data to a user. For example, the display module 250 can include a panel or a hologram. For example, the panel can be an LCD or an AM-OLED. Also, the panel can be implemented such that it is flexible, transparent, or wearable. Here, the panel can be configured as one module with a touch panel. For example, a hologram can be configured to show a three-dimensional (3-D) image in air using interference of light. Additionally, the display module 250 can further include a control circuit for controlling a panel or a hologram.

Also, the display module 250 can be configured to display a screen under control of the display control program 232. For example, the display module 250 can be configured to display a list of applications installed to an external electronic device according to a request of the display control program 232.

The communication module 260 can be configured to connect communication between the electronic device 200 and other electronic devices 202 and 204. At this point, the communication module 260 can be configured to support a short distance communication protocol (such as Wi-Fi, BT, NFC, or a network communication (such as the Internet, LAN, WAN, a telecommunication network, a cellular network, a satellite network, or POTS, 262)).

Each of the other electronic devices 202 and 204 can be a device which is the same (such as a same type) as the electronic device 200, or a different device (such as a different type).

The electronic device can further include a sensor module. Here, the sensor module can include at least one of an illuminance sensor, a gesture sensor, a proximity sensor, a gyro sensor, an atmospheric pressure sensor, a magnetic sensor, an acceleration sensor, a grip sensor, a RGB sensor, a living body sensor, a temperature/humidity sensor, a UV sensor, and a Hall sensor. Also, the sensor module can be configured to measure a physical quantity or detect an operation state of the electronic device to convert measured or detected information to an electric signal. Also, the sensor module can include a smell sensor, an EMG sensor, an EEG sensor, an ECG sensor, or a fingerprint sensor. Also, the sensor module can further include a control circuit for controlling one or more sensors belonging thereto. For example, the electronic device can be configured to detect brightness of neighborhood using an illuminance sensor. For another example, the electronic device can be configured to determine whether a flip cover is opened or closed using a gesture sensor, a proximity sensor, or a Hall sensor.

Names of hardware elements according to various embodiments can change depending on the kind of an electronic device. A hardware according to various embodiments can include at least one of elements, and some of the elements can be omitted or can include additional another element. Also, a portion of hardware elements according to various embodiments can be combined to form one entity and equally perform functions of relevant elements before the combination.

FIG. 3 is an example block diagram illustrating a processor according to this disclosure.

As illustrated in FIG. 3, the processor 220 can include an external electronic device manager 310 and a display controller 320.

The external electronic device manager 310 can be configured to execute an external electronic device management program 231 stored in the memory 230 to manage an application. For example, the external electronic device manager 310 can be configured to determine an application install file for an external electronic device based on an install information variable included in the application install file received from a server. Here, the install information variable can include information for determining an external electronic device to which the application install file can be installed. In case of the application install file for the external electronic device, the external electronic device manager 310 can be configured to control to transmit the application install file to the external electronic device via the communication module 260. After that, the external electronic device manager 310 can be configured to update an application list of an external electronic device based on an installation result of an application install file received from the external electronic device via the communication module 260.

Also, the external electronic device manager 310 can be configured to request the display controller 320 to control to display a list of applications installed to the external electronic device. The external electronic device manager 310 can be configured to control to transmit management information regarding at least one application among one or more applications included in an application list to the external electronic device via the communication module 260 based on input information detected via the user input module 240. Here, the management information can include at least one of deletion, update, and correction of an application. In case of transmitting the management information to the external electronic device, the external electronic device manager 310 can be configured to receive a performance result for management information from the external electronic device, and update the application list of the external electronic device based on the performance result for the management information.

The display controller 320 can be configured to execute the display control program 232 stored in the memory 230 to control to display an application management screen via the display module 250. For example, the display controller 320 can be configured to control to display a list of applications installed to an external electronic device via the display module 250 according to a request of the external electronic device manager 310.

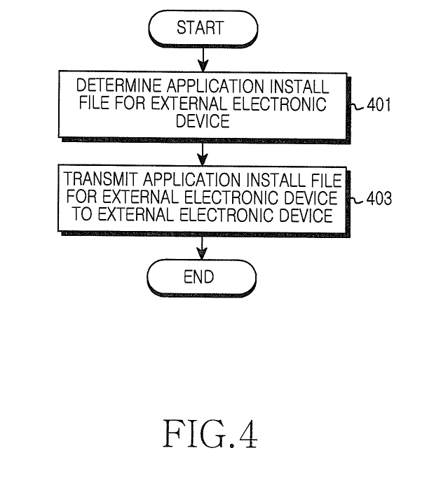

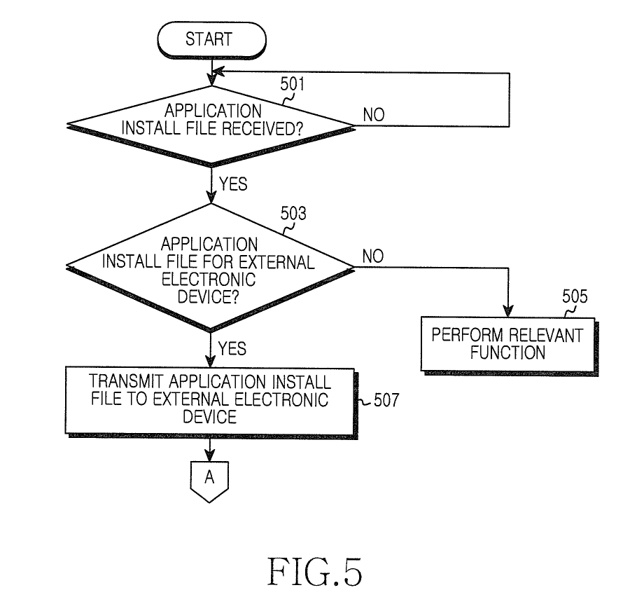

FIG. 4 is an example flowchart illustrating a procedure for transmitting an application install file for an external electronic device to the external electronic device in an electronic device according to this disclosure.

Referring to FIG. 4, the electronic device can determine an application install file for an external electronic device in step 401. For example, the electronic device can receive an application install file from a server, and determine an application install file for an external electronic device based on an install information variable included in the received application install file. Here, the install information variable can include information for determining an external electronic device to which the application install file can be installed. For example, the install information variable can include at least one of a model name of an electronic device, an International Mobile Equipment Identity (IMEI), and an MAC address (such as Bluetooth, Wi-Fi). For another example, the electronic device can receive an application install file for an external electronic device from a server.

The electronic device can transmit the application install file for the external electronic device to the external electronic device in step 403. At this point, the electronic device can receive an installation result of the application install file from the external electronic device, and update an application list of the external electronic device based on the installation result.

FIG. 5 is an example flowchart illustrating a procedure for transmitting an application install file for an external electronic device to the external electronic device in an electronic device according to this disclosure.

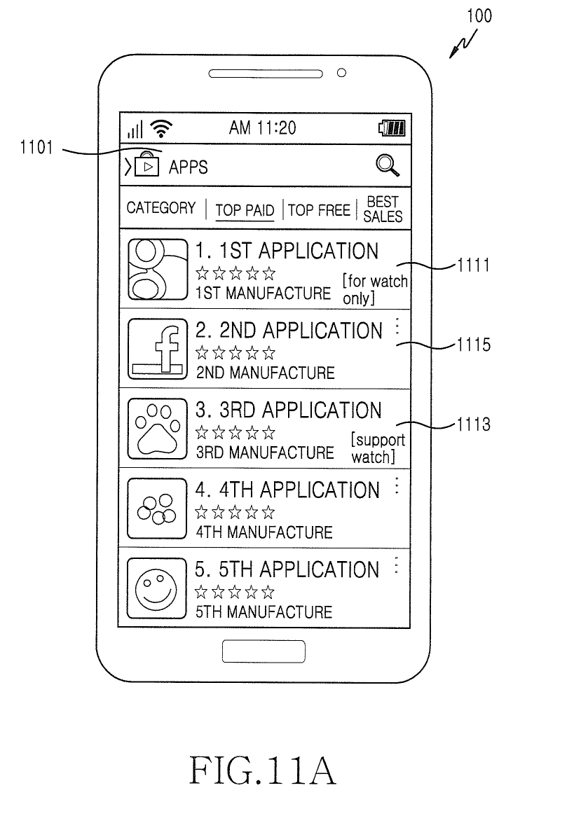

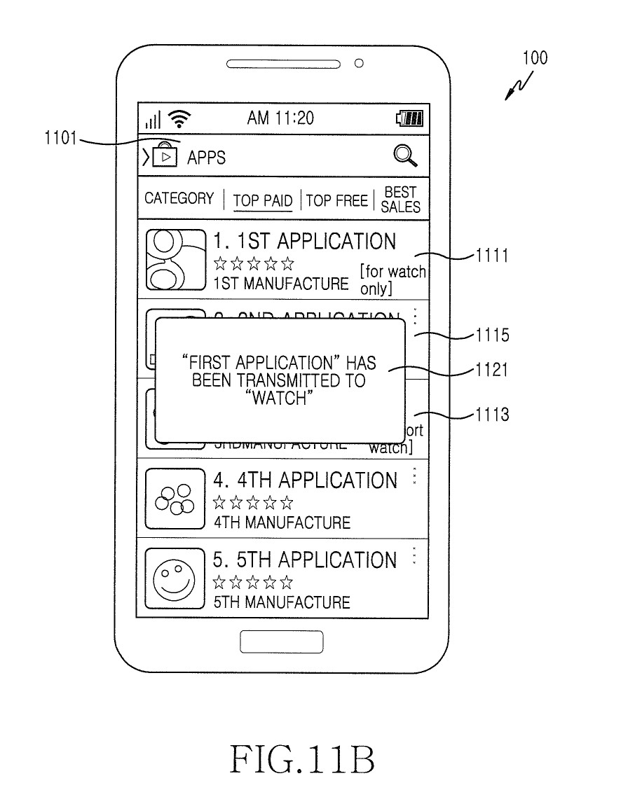

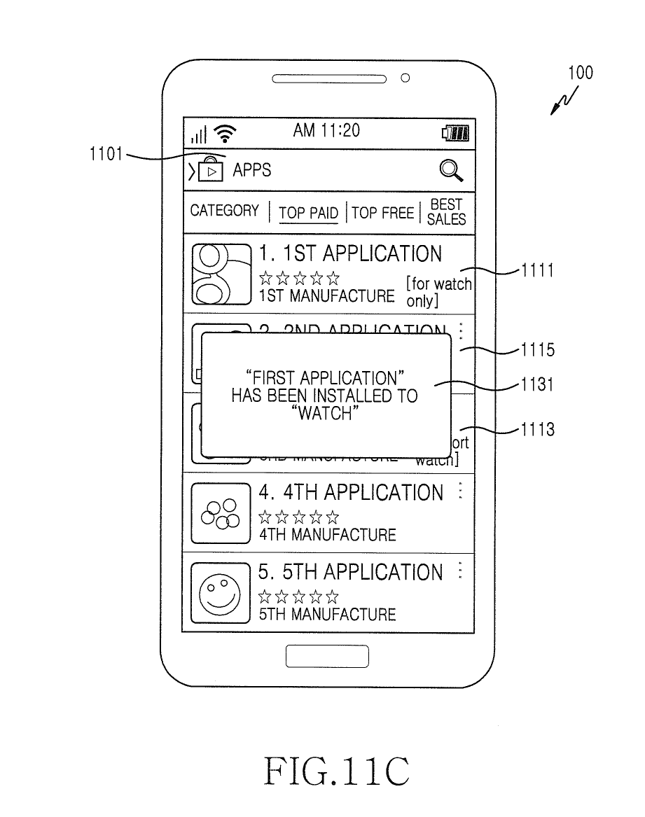

Referring to FIG. 5. the electronic device can determine whether an application install file is received in step 501. For example, as illustrated in FIG. 11A, the electronic device 100 can determine whether an application install file is received based on a user's selection of at least one application among applications 1111, 1113, 1115 provided by an application provide server 1101. Here, though the electronic device exemplarily describes an application provided by a server, the application is not limited thereto and can be an application stored in a memory of the electronic device in advance. In this case, the electronic device can determine whether an install event for the application install file stored in the memory in advance occurs.

When receiving an application install file, the electronic device can determine an application stall file for an external electronic device in step 503. For example, when receiving an install file of a “first application” 1111 among the applications 1111, 1113, 1115 illustrated in FIG. 11A, the electronic device 100 can determine an application install file for an external electronic device based on an install information variable of the received install file of the “first application” 1111.

Here, the install information variable can include information of the electronic device to which the application install file can be installed. For example, the install information variable can include at least one of a model name of the electronic device, an International Mobile Equipment Identity (IMEI), and an MAC address (such as Bluetooth, Wi-Fi). For another example, the electronic device can determine whether the application install file is an application install file for an external electronic device.

In the case where the application install file is not the application install file for the external electronic device, the electronic device can end the present algorithm. For example, in the case where information corresponding to an external electronic device connected with the electronic device is not included in an install information variable of the install file of the “first application” 1111, the electronic device can recognize the install file of the “first application” 1111 is not the application install file for the external electronic device. Accordingly, the electronic device can perform installation of an application install file.

Meanwhile, in the case where the application install file is the application install file for the external electronic device, the electronic device can transmit the application install file to the external electronic device in step 505. For example, in the case where information corresponding to an external electronic device connected with the electronic device is included in an install information variable of the install file of the “first application” 1111, the electronic device can transmit the install file of the “first application” 1111 to at least one external electronic device (such as a watch) connected via short distance wireless communication. At this point, as illustrated in FIG. 11B, the electronic device 100 can display an inform window 1121 for informing that the “first application” is transmitted to a “watch” (such as an external electronic device).

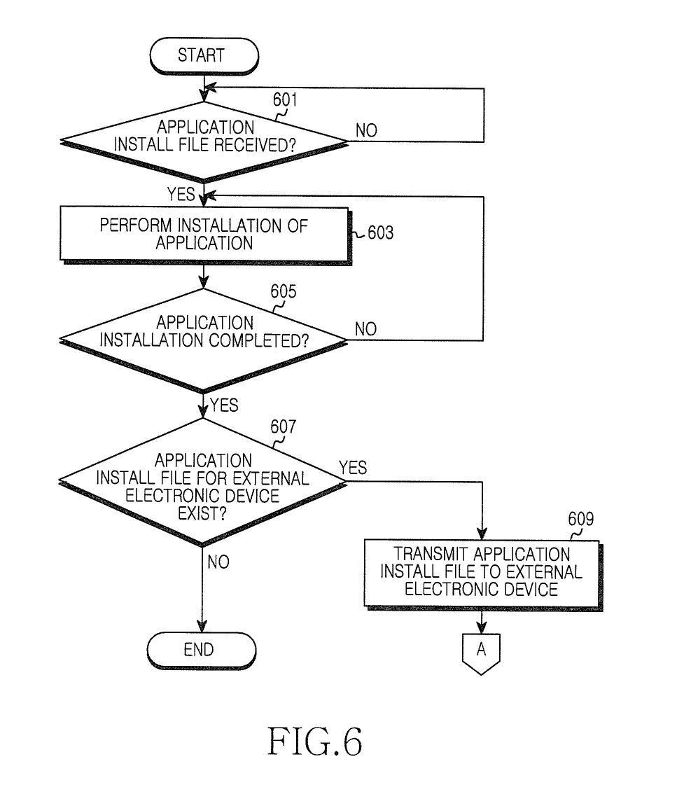

In the above embodiment, in case of receiving the application install file, the electronic device can determine whether the application install file is an application install file for an external electronic device to perform a relevant function. In another embodiment, as illustrated in FIG. 6, when receiving the application install file, the electronic device can complete installation of the application install file, and then can determine whether an application install file for an external electronic device exists.

FIG. 6 is an example flowchart illustrating a procedure for transmitting an application install file for an external electronic device to the external electronic device in an electronic device according to this disclosure.

Referring to FIG. 6, the electronic device can determine whether the application install file is received in step 601. For example, as illustrated in FIG. 11A, the electronic device 100 can determine whether the application install file is received based on a user's selection of at least one application among applications 1111, 1113, 1115 provided by an application provide server 1101. Here, though the electronic device has exemplarily described an application provided by a server, the application is not limited thereto but can be an application stored in advance. In this case, the electronic device can determine whether an install event for the application install file stored in the memory in advance occurs.

When receiving the application install file, the electronic device can perform installation of the application install file in step 603. For example, when receiving the install file of the “first application” 1111 among the applications 1111, 1113, 1115 illustrated in FIG. 11A, the electronic device 100 can perform installation of the received install file of the “first application” 1111.

After that, the electronic device can determine whether installation of the application install file is completed in step 605. When the installation is not completed, the electronic device can perform installation of the application install file in step 603.

Meanwhile, when the installation is completed, the electronic device can determine whether an application install file for an external electronic device exists in step 607. For example, in case of completing installation of the install file of the “first application” 1111 illustrated in FIG. 11A, the electronic device 100 can determine whether the application install file for the external electronic device exists based on an install information variable of the install file of the “first application” 1111. Here, the install information variable can include information of the electronic device to which the application install file can be installed in the electronic device. For example, the install information variable can include at least one of a model name of the electronic device, an International Mobile Equipment Identity (IMEI), and an MAC address (such as Bluetooth, Wi-Fi). For another example, the electronic device can determine whether the application install file for the external electronic device exists.

In the case where the application install file for the external electronic device does not exist, the electronic device can end the present algorithm. For example, in the case where information corresponding to an external electronic device connected with the electronic device is not included in the install information variable of the install file of the “first application” 1111, the electronic device can recognize the application install file for the external electronic device does not exist in the install file of the “first application” 1111.

Meanwhile, in the case where the application install file for the external electronic device exists, the electronic device can transmit the application install file to the external electronic device in step 609. For example, in the case where information corresponding to an external electronic device connected with the electronic device is included in the install information variable of the install file of the “first application” 1111, the electronic device can transmit the install file of the “first application” 1111 to at least one external electronic device (such as a watch) connected via short distance wireless communication. At this point, as illustrated in FIG. 11B, the electronic device 100 can display an inform window 1121 for informing that the “first application” is transmitted to a “watch” (such as an external electronic device).

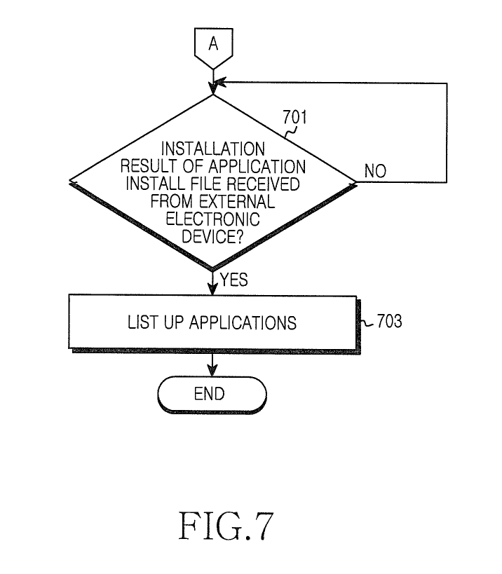

In the above embodiment, in the case where the application install file is an application for an external electronic device, the electronic device can transmit the application install file to the external electronic device. After that, as illustrated in FIG. 7, the electronic device can receive an installation result for an application install file from the external electronic device.

FIG. 7 is an example flowchart illustrating a procedure for receiving an installation result for an application install file from an external electronic device in an electronic device according to this disclosure.

Referring to FIG. 7, in case of transmitting the application install file to an external electronic device in step 507 of FIG. 5 or step 609 of FIG. 6, the electronic device can determine whether an installation result for the application install file is received from the external electronic device in step 701. For example, in case of transmitting the “first application” to the “watch”, the electronic device can receive whether installation of the “first application” is completed from the external electronic device.

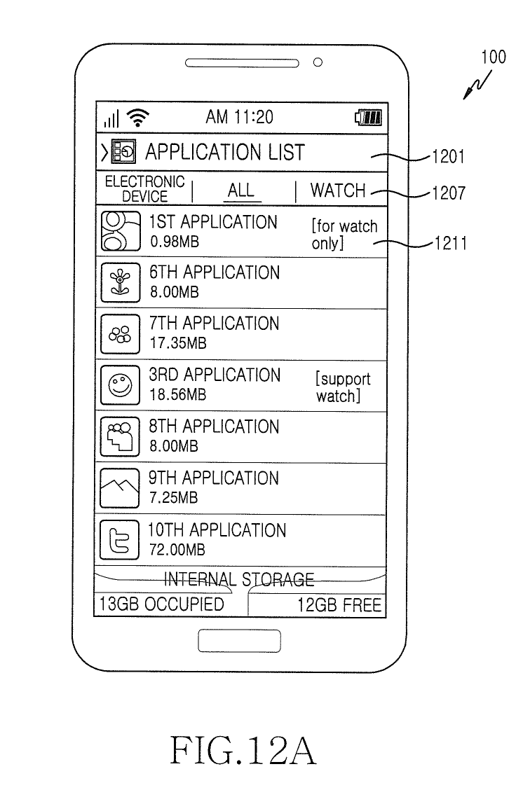

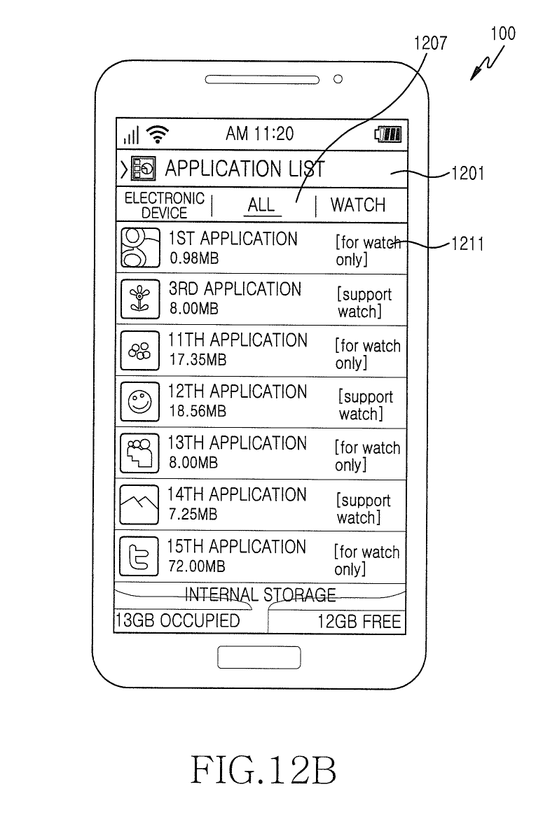

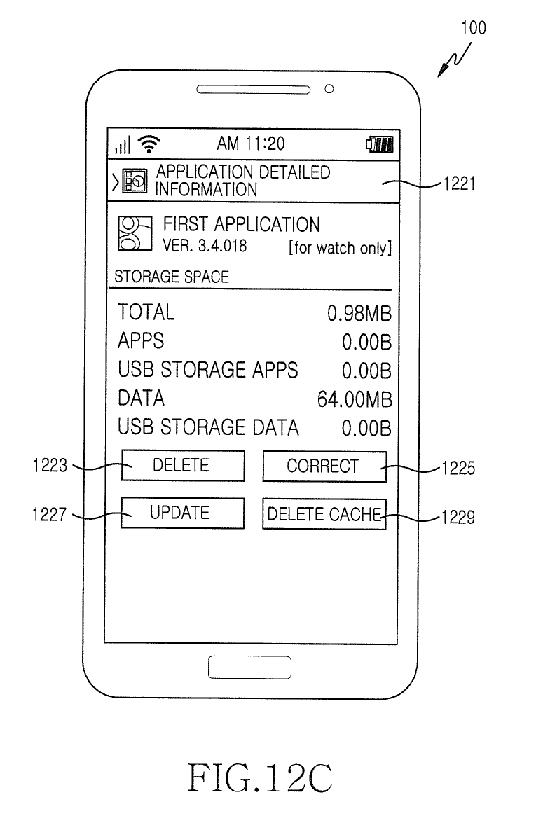

In case of receiving an installation result for the application install file, the electronic device can list up applications in step 703. At this point, as illustrated in FIG. 11C, the electronic device 100 can display an inform window 1131 for informing that the “first application” has been installed to a “watch” (such as an external electronic device). For example, when receiving installation completion of the “first application” from the “watch”, the electronic device can include a “first application” 1211 in an “application list” 1201 as illustrated in FIG. 12A. In the case where selection of the “watch” 1207 is detected in the “application list” 1201, the electronic device 100 can display only applications installed to the “watch” as illustrated in FIG. 12B. Also, in the case where selection of the “first application” 1211 is detected in FIG. 12A or 12B, the electronic device 100 can display “detailed information regarding the first application” 1221 as illustrated in FIG. 12C.

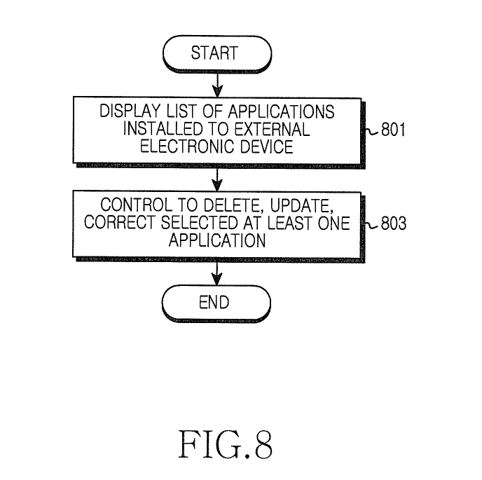

In the above embodiment, the electronic device can manage lists up applications installed to the external electronic device. At this point, the electronic device can control an application installed to the external electronic device via the application list as illustrated in FIG. 8.

FIG. 8 is an example flowchart illustrating a procedure for controlling deletion, update, or correction of an application installed to an external electronic device in an electronic device according to this disclosure.

Referring to FIG. 8, the electronic device can display a list of applications installed to an external electronic device in step 801. For example, in the case where an application list display event occurs, the electronic device can display at least one application including the “first application 1211” in the “application list” 1201 as illustrated in FIG. 12A. Also, in the case where selection of the “watch” 1207 is detected in the “application list” 1201, the electronic device 100 can display only applications installed to the “watch” as illustrated in FIG. 12B. Also, in the case where selection of the “first application” 1211 is detected in FIG. 12A or 12B, the electronic device 100 can display the “detailed information regarding the first application” 1221 as illustrated in FIG. 12C.

In step 803, the electronic device can control at least one of deletion, update, and correction of selected at least one application. For example, in the case where selection of the “first application” 1211 is detected in FIG. 12A or 12B, the electronic device 100 can display the “detailed information regarding the first application” 1221 as illustrated in FIG. 12C. At this point, in the case where selection of at least one menu among “delete” 1223, “correct” 1225, “update” 1227, and “delete cache” 1229 is detected, the electronic device 100 can transmit the selected management information to an external electronic device.

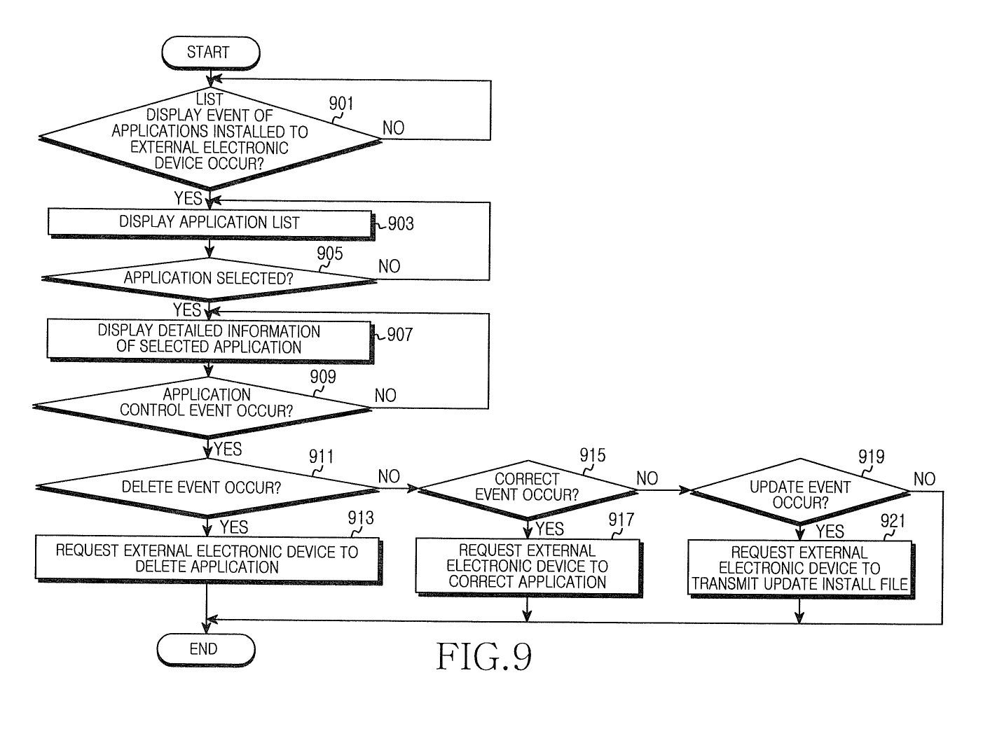

FIG. 9 is an example flowchart illustrating a procedure for controlling deletion, update, or correction of an application installed to an external electronic device in an electronic device according to this disclosure.

Referring to FIG. 9, the electronic device can determine whether a list display event of applications installed to the external electronic device occurs in step 901. For example, the electronic device can determine whether a menu for displaying an application list is selected. For another example, the electronic device can determine whether a touch input for displaying the application list is detected. For still another example, the electronic device can determine whether a gesture for displaying an application list is detected.

In the case where an application list display event occurs, the electronic device can display a list of applications installed to the external electronic device in step 903. For example, in the case where an application list display event occurs, the electronic device can display at least one application including the “first application” 1211 in the “application list” 1201 as illustrated in FIG. 12A. Also, in the case where selection of the “watch” 1207 is detected in the “application list” 1201, the electronic device 100 can display only applications installed to the “watch” as illustrated in FIG. 12B. Also, in the case where selection of the “first application” 1211 is detected in FIG. 12A or 12B, the electronic device 100 can display the “detailed information regarding the first application” 1221 as illustrated in FIG. 12C.

After displaying the application list, the electronic device can determine whether at least one application is selected from the application list in step 905. In the case where the application is not selected, the electronic device can maintain application list display in step 903.

Meanwhile, in the case where an application is selected, the electronic device can display detailed information of the selected application in step 907. For example, in the case where selection of the “first application” 1211 is detected in FIG. 12A or 12B, the electronic device 100 can display the “detailed information regarding the first application” 1221 as illustrated in FIG. 12C.

After displaying the detailed information of the application, the electronic device can determine whether an application control event occurs in step 909. For example, the electronic device can determine whether selection of at least one menu among “delete” 1223, “correct” 1225, “update” 1227, and “delete cache” 1229 is detected in the “detailed information regarding the first application” 1221 illustrated in FIG. 12C. In the case where an application control event does not occur, the electronic device 100 can maintain detailed information display of an application in step 907.

Meanwhile, in the case where the application control event occurs, the electronic device can determine whether a delete event occurs in step 911. In the case where a delete event occurs, the electronic device can request to delete an application installed to an external electronic device in step 913. For example, in the case where selection of a menu of the “delete” 1223 is detected in the “detailed information regarding the first application” 1221 illustrated in FIG. 12C, the electronic device 100 can request the external electronic device to delete the “first application” 1211.

In the case where an event is not the delete event, the electronic device can determine whether a correct event occurs in step 915. In the case where the correct event occurs, the electronic device can request the external electronic device to delete an application in step 917. For example, in the case where selection of a menu of the “correct” 1225 is detected in the “detailed information regarding the first application” 1221 illustrated in FIG. 12C, the electronic device 100 can request the external electronic device to correct at least one of a name and an icon of the “first application” 1211.

In the case where an event is not the correct event, the electronic device can determine whether an update event occurs in step 919. In the case where the update event occurs, the electronic device can transmit an application update file to the external electronic device in step 921. For example, in the case where selection of a menu of the “update” 1227 is detected in the “detailed information regarding the first application” 1221 illustrated in FIG. 12C, the electronic device 100 can transmit an update file of the “first application” 1211 to the external electronic device and request the external electronic device to install the same. Here, the electronic device can request a server initially accessed for installing the “first application” 1211 to transmit the update file and receive the update file.

In the case where an event is not the update event, the electronic device can perform a “delete cache” event 1229. For example, the electronic device can request the external electronic device to delete a stored temporary file while performing at least one of install, execute, correct, and update on the “first application” 1211.

In the above embodiment, when a control event of an application occurs, the electronic device can request the external electronic device to perform a relevant control event. At this point, the electronic device can receive a performance result of the relevant control event from the external electronic device.

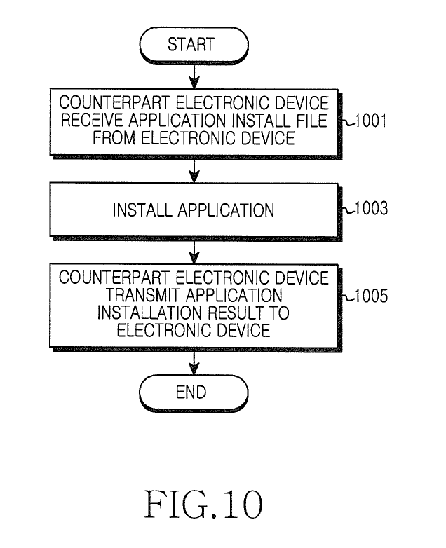

FIG. 10 is an example flowchart illustrating a procedure for performing installation of an application install file received from a electronic device in an counterpart electronic device according to this disclosure.

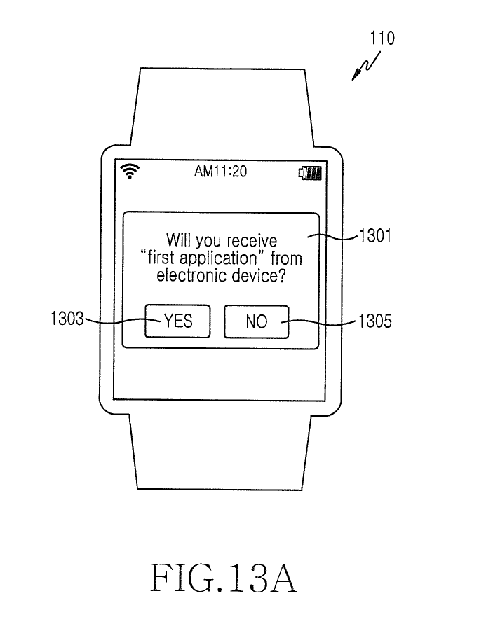

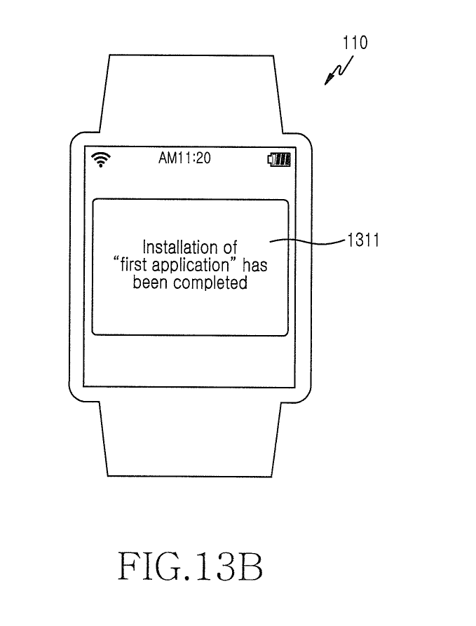

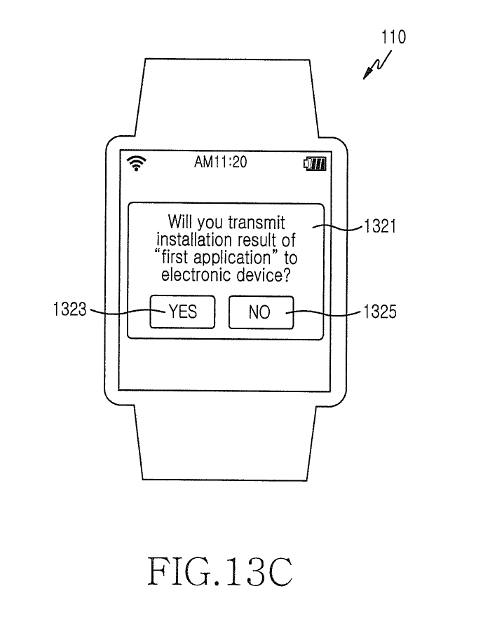

Referring to FIG. 10, the counterpart electronic device 110 can receive an application install file from the electronic device 100 in step 1001. For example, in the case where an application install file reception request occurs from the electronic device 100, a “watch” 110 can display an inform window 1301 via which whether to receive the “first application” from the electronic device 100 can be determined as illustrated in FIG. 13A. At this point, in the case where selection of “Yes” 1303 displayed on the inform window 1301 is detected, the counterpart electronic device 110 can recognize that the “first application” is received from the electronic device 100. In contrast, in the case where selection of “No” 1305 displayed on the inform window 1301 is detected, the counterpart electronic device 110 can recognize that the “first application” has not been received from the electronic device 100. Additionally, the counterpart electronic device can be set to immediately receive the “first application” without determining whether to receive the “first application” from the electronic device 100.

The counterpart electronic device 110 can perform application installation in step 1003. For example, in case of receiving the “first application” from the electronic device 100, the counterpart electronic device 110 can perform installation of the “first application”. At this point, the counterpart electronic device 110 can display an installation result of the “first application” on the inform window 1311 as illustrated in FIG. 13B.

In step 1005, the counterpart electronic device 110 can transmit the application installation result to the electronic device 100. For example, in case of completing installation of the “first application”, the counterpart electronic device 110 can display an inform window 1321 via which whether to transmit the installation result of the “first application” to the electronic device 100 can be determined as illustrated in FIG. 13C. At this point, in the case where selection of “Yes” 1323 displayed on the inform window 1321 is detected, the counterpart electronic device 110 can recognize that it has transmitted the installation result of the “first application” to the electronic device 100. In contrast, in the case where selection of “No” 1325 displayed on the inform window 1321 is detected, the counterpart electronic device 110 can recognize that it has not transmitted the installation result of the “first application” to the electronic device 100. Additionally, the counterpart electronic device 110 can be set to immediately transmit the installation result of the “first application” without determining whether to transmit the installation result of the “first application” to the electronic device 100.

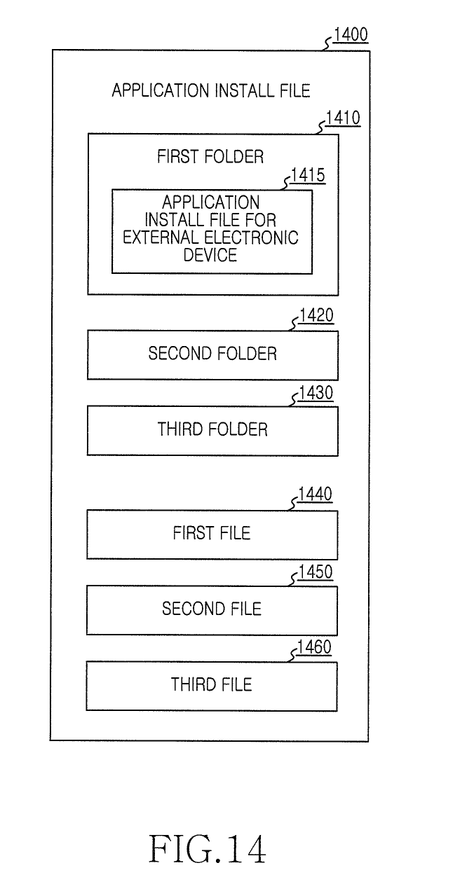

FIG. 14 is an example of an application install file according to this disclosure.

Referring to FIG. 14, an application install file 1400 can include one or more folders such as a first folder 1410, a second folder 1420, and a third folder 1430, and one or more files such as a first file 1440, a second file 1450, and a third file 1460. Here, the application install file 1400 can be an APK file of an android Operating System (OS).

The first folder 1410 can be a folder for storing data regarding an external resource of an application or a software program. For example, the first folder 1410 can be an “asset” folder of an APK file of the android OS. According to various embodiments of the present disclosure, the first folder 1410 can include an application install file 1415 for an external electronic device.

According to an embodiment, as illustrated in FIG. 14, the application install file 1415 for the external electronic device can be positioned in the first folder 1410 of the application install file 1400. In an embodiment the application install file 1415 for the external electronic device can be positioned in another folder or another position of the application install file 1400.

The second folder 1420 can be configured to store meta information data of an application itself. Here, the meta information data of the application itself can include content in which a user has written his signature via an authentication certificate when the application has been distributed. For example, the second folder 1420 can be an “META-INF” folder of an APK file of the android OS.

The third folder 1430 can be a folder for storing data regarding an internal resource of an application or a software program. For example, the third folder 1430 can be an “META-INF” folder of an APK file of the android OS.

The first file 1440 is a file for storing basic setting information of an application, and can be a file referred first among a plurality of files forming an application. For example, the first file 1440 can be “AndroidManifest.xml” of the android OS. According to various embodiments, an install information variable can be included in the first file 1440.

The second file 1450 is a file generated by compiling a source code of an application, and can include information of classes forming an operation of the application. For example, the second file 1450 can be “classes.dex” of the android OS.

The third file 1460 can include resources compiled in advance before execution of an application. For example, the third file 1460 can be “resources.arsc” of the android OS.

As described above, the electronic device can raise usability of an external electronic device where a size of a display unit is limited by managing an application of the external electronic device.

Although the disclosure has been shown and described with reference to certain exemplary embodiments thereof, it will be understood by those skilled in the art that various changes in form and details can be made therein without departing from the spirit and scope of the disclosure as defined by the appended claims and their equivalents. Therefore, the scope of the present disclosure should not be limited to the above-described embodiments but should be determined by not only the appended claims but also the equivalents thereof.

What is claimed is:

1. A method for use in an electronic device, the method comprising:
determining application data for an external electronic device; and
transmitting the application data for the external electronic device to the external electronic device.

2. The method of claim 1, wherein determining the application data for the external electronic device comprises:
receiving application data; and
determining whether the application data is application data for the external electronic device based on an install information variable included in the application data.

3. The method of claim 2, wherein the install information variable comprises information for determining an external electronic device to which the application data is installed.

4. The method of claim 1, wherein determining the application data for the external electronic device comprises:
receiving the application data for the external electronic device from a server.

5. The method of claim 1, further comprising:
after the application data is transmitted to the external electronic device, receiving an installation result of the application data from the external electronic device; and
updating an application list of the external electronic device based on the installation result of the application data.

6. The method of claim 1, wherein the application data comprises an install file installed and executed to at least one of the electronic device and the external electronic device.

7. A method in an electronic device, the method comprising:
displaying a list of applications installed to an external electronic device; and
transmitting management information regarding at least one application among one or more applications included in the application list to at least one external electronic device based on input information detected via an input unit of the electronic device.

8. The method of claim 7, wherein the management information comprises at least one of deletion, update, and correction of the application.

9. The method of claim 7, further comprising:
after the management information is transmitted to the external electronic device, receiving a performance result of the management information from the external electronic device; and
updating the application list of the external electronic device based on the performance result of the management information.

10. A method for managing an application in an electronic device, the method comprising:
receiving application data from a counterpart electronic device;
installing the received application data; and
transmitting an installation result of the application data to the counterpart electronic device.

11. The method of claim 10, further comprising:
performing at least one of deletion, update, and correction on at least one application installed to the electronic device based on management information received from the counterpart electronic device.

12. The method of claim 10, wherein the application data comprises an install file installed and executed to at least one of the electronic device and the counterpart electronic device.

13. An electronic device comprising:
one or more displays;
one or more memories; and
one or more processors configured to determine application data for an external electronic device, and transmit the application data for the external electronic device to the external electronic device.

14. The electronic device of claim 13, wherein the processor is configured to receive the application data, and determine whether the application data is application data for the external electronic device based on an install information variable included in the application data.

15. The electronic device of claim 14, wherein the install information variable comprises information for determining the external electronic device to which the application data is installed.

16. The electronic device of claim 13, wherein the processor is configured to receive the application data for the external electronic device from a server.

17. The electronic device of claim 13, wherein after the application data is transmitted to the external electronic device, the processor is configured to receive an installation result of the application data from the external electronic device, and update an application list of the external electronic device based on the installation result of the application data.

18. The electronic device of claim 13, wherein the application data comprises an install file installed and executed to at least one of the electronic device and the external electronic device.

19. An electronic device comprising:
one or more displays;
one or more input units;
one or more memories; and
one or more processors configured to display an application list installed to an external electronic device on the display, and transmit management information regarding at least one application among one or more applications included in the application list to at least one external electronic device based on input information detected via the input unit.

20. The electronic device of claim 19, wherein the management information comprises at least one of deletion, update, and correction of the application.

21. The electronic device of claim 19, wherein after the management information is transmitted to the external electronic device, the processor is configured to receive a performance result of the management information from the external electronic device, and update an application list of the external electronic device based on the performance result of the management information.

22. An electronic device comprising:
one or more displays;
one or more memories; and
one or more processors configured to receive application data from a counterpart electronic device, install the received application data, and transmit an installation result of the application data to the counterpart electronic device.

23. The electronic device of claim 22, wherein the processor is configured to perform at least one of deletion, update, and correction on at least one application installed to the electronic device based on management information received from the counterpart electronic device.

24. The electronic device of claim 22, wherein the application data comprises an install file installed and executed to at least one of the electronic device and the counterpart electronic device.
